(19) United States
(12) Patent Application Publication
(10) Pub. No.: US 2010/0071515 A1
(43) Pub. Date: Mar. 25, 2010

(54) Nail set

(76) Inventor: Tino S. Teng, Taipei (TW)

Correspondence Address: Tino S. Teng, P.O. Box 24-108, Taipei, TW

(21) Appl. No.: 12/284,456

(22) Filed: Sep. 23, 2008

(51) Int. Cl. B25C 3/00

(52) U.S. Cl. 81/44

(57) ABSTRACT

A nail set includes a nail to be driven by a nail gun into a workpiece, and a stub screw rod to be fastened to the workpiece with the nail. The stub screw rod has an axial through hole approximately equal to the diameter of the shank of the nail for the passing of the nail so that when the nail is driven into the workpiece, the stub screw rod is carried by the nail and stopped between the workpiece and the head of the nail.

### BACKGROUND OF THE INVENTION

1. Field of the Invention:

The present invention relates to a nail gun technology and more specifically, to a nail set for nail gun.

2. Description of the Related Art:

Many kinds of nail guns and like tools are known for driving nails into by electromagnetism, compressed air or highly flammable gases. Further, screw head nails 3 may be used and driven into a workpiece for the mounting of an external device (see FIG. 1). For driving different sizes X of screw head nails 3, different nail guns or like tools should be used. It is not economic to purchase many nail guns or like tools for driving different sizes of screw head nails 3.

### SUMMARY OF THE INVENTION

The present invention has been accomplished under the circumstances in view. It is one object of the present invention to provide a nail set, which allows installation of different sizes of stub screw rods with one same size of nail by one same nail gun. To achieve this and other objects of the present invention, the nail set comprises a nail to be driven by a nail gun into a workpiece, and a stub screw rod to be fastened to the workpiece with the nail. The stub screw rod has an axial through hole approximately equal to the diameter of the shank of the nail for the passing of the nail so that when the nail is driven into the workpiece, the stub screw rod is carried by the nail and stopped between the workpiece and the head of the nail. Further, the axial through hole of the stub screw rod can be a circular hole, hexagonal hole, pentagonal hole, or any kind of other polygonal holes.

### BRIEF DESCRIPTION OF THE DRAWINGS

FIG. 1 is a prior art showing two different sizes of conventional popped nails.

FIG. 2 is an exploded view of a nail set according to the present invention.

FIG. 3 is an exploded view of an alternate form of the nail set according to the present invention.

FIG. 4 is an elevational view of another alternate form of the stub screw rod according to the present invention.

FIG. 5 is a schematic drawing showing an application example of the present invention (Step I).

FIG. 6 is a schematic drawing showing an application example of the present invention (Step II).

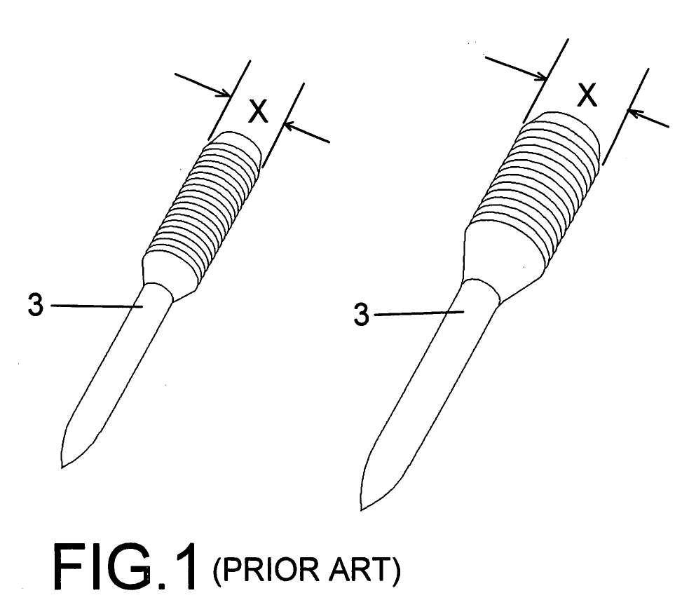

### DETAILED DESCRIPTION OF THE PREFERRED EMBODIMENT

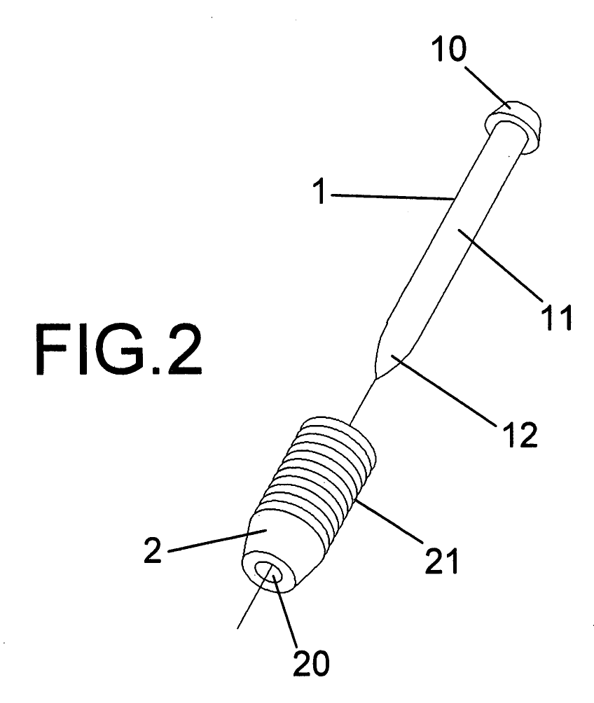

Referring to FIG. 2, a nail set is shown comprising a nail 1 and a stub screw rod 2.

The nail 1 comprises a shank 11, a head 10 at one end of the shank 11, and a point 12 at the other end of the shank 11. The nail 1 can be loaded in a nail gun or like tool and driven by the nail gun or like tool into wood or some other kind of materials. The stub screw rod 2 has an axial center through hole 20 axially cut through the two distal ends thereof, and outer threads 21 extending around the periphery. The stub screw rod 2 has a length much shorter than the shank 11 of the nail 1. The diameter of the axial center through hole 20 is approximately equal to the diameter of the shank 11 of the nail 1 but smaller than the diameter of the head 10 of the nail 1.

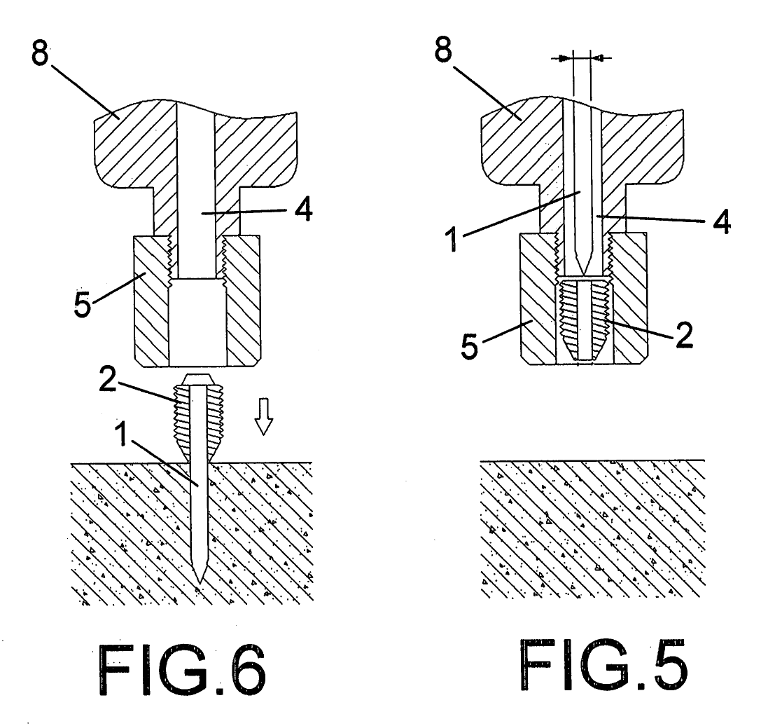

Referring to FIGS. 5 and 6, during application of the present invention, the nail 1 is loaded in a nail gun 8 (in actual paractice, multiple nails are mounted in long strips or in a plastic carrier coil, depending on the design of the nail gun), and then a socket 5 is attached to the front end of the gunbarrel of the nail gun 8 to hold the stub screw rod 2 and stopped agaisnt the workpiece, and then the nail gun is operated to drive the nail 1 into the workpiece and to have the stub screw rod 2 be carried by the nail 1 and stopped between the workpiece and the head 10 of the nail 1.

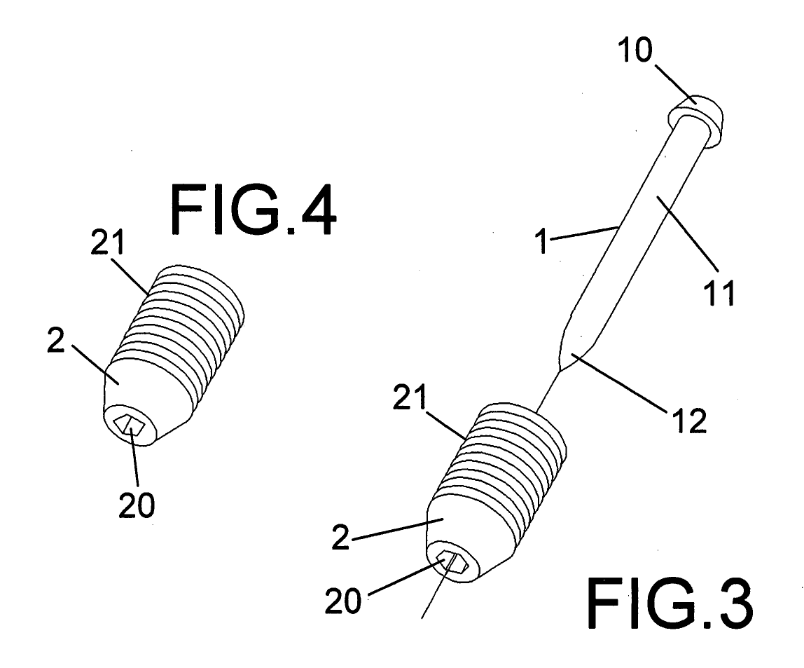

Referring to FIGS. 3 and 4 and FIG. 2, the axial center through hole 20 of the stub screw rod 2 can be made having a circular cross section as shown in FIG. 2, hexagonal cross section as shown in FIG. 3, a pentagonal cross section as shown in FIG. 4, or any other kind of cross sectional configurations.

By means of the present invention, different sizes of stub screw rods 2 can be selectively used with the nail 1.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A nail set, comprising:
a nail drivable by a nail gun into a workpiece, said nail comprising a shank, a head at one end of said shank, and a point at an opposite end of said shank 11. The nail 1 can be loaded in a nail gun or like tool and driven by the nail gun or like tool into wood or some other kind of materials; and
a stub screw rod fastenable to a workpiece with said nail, said stub screw rod comprising an axial center through hole axially cut through two distal ends thereof, and outer threads extending around the periphery thereof, said stub screw rod having a length much shorter than said shank of said nail, said axial center through hole having a diameter approximately equal to the diameter of said shank of said nail and smaller than the diameter of said head of said nail.

2. The nail set as claimed in claim 1, wherein said axial through hole is a polygonal through hole.
